(19) United States
(12) Patent Application Publication
(10) Pub. No.: US 2009/0057619 A1
(43) Pub. Date: Mar. 5, 2009

(54) Compositions and Visual Perception Changing Methods

(76) Inventors: Stephen Allen Goldman, Cincinnati, OH (US); John David Carter, Mason, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/198,156

(22) Filed: Aug. 26, 2008

Related U.S. Application Data
(60) Provisional application No. 60/966,953, filed on Aug. 31, 2007.

(51) Int. Cl. C09K 3/00

(52) U.S. Cl. 252/408.1

(57) ABSTRACT

A composition includes at least one visual indicator dye and a surfactant. Upon dilution of the composition with a volume of water a diluted product is formed, and wherein: i) the extinction coefficient of the composition is less than the extinction coefficient of the diluted product measured at a wavelength from about 400 nm to about 700 nm; ii) a ratio of an absorbance measured between about 550-650 nm and an absorbance measured between about 395-440 nm increases upon increasing dilution of the composition; and/or iii) the pKₐ of the composition is greater than the pKₐ of the diluted product. Additionally, methods for changing the visual perception of a composition comprise diluting a composition.

### CROSS REFERENCE TO RELATED APPLICATION

This application claims the benefit of U.S. Provisional Application No. 60/966,953, filed Aug. 31, 2007.

### FIELD OF THE INVENTION

The present invention is directed to compositions including at least one visual indicator dye and a surfactant and to methods of changing the visual perception of a composition.

### BACKGROUND OF THE INVENTION

Consumers often base their opinions of a product on cues they receive during the use of the product. The whiff of a perfume to indicate freshness, the snapping noise of a lid closing onto a container, and the presence of suds in detergents are just a few examples of cues that consumers have come to rely upon that the product is working. Oppositely, manufactures often rely upon the end results (e.g., whiter fabrics, removal of soils from surfaces, shiner surfaces) for consumers to understand the benefit that they are receiving from a product.

Consumer research has shown that one of the key reasons consumers stop washing their dishes is the appearance of dirty dishwashing solutions. Typically, this is a reddish brown hue resulting from the removal of both grease and particulate based soils. Consumers view this reddish brown hue as a signal that the water is dirty and therefore ineffective to clean any more dishes. This, however, is untrue. Thus, there are needs for which to change the visual perception of the water and thus allow the consumer to continue using a product to its full extent.

### SUMMARY OF THE INVENTION

One embodiment of the present invention is directed to a composition including at least one visual indicator dye and a surfactant. Upon dilution of the composition with a volume of water, a diluted product is formed, and wherein: i) the extinction coefficient of the composition is less than the extinction coefficient of the diluted product measured at a wavelength from about 400 nm to about 700 nm; ii) a ratio of an absorbance measured between about 550-650 nm and an absorbance measured between about 395-440 nm increases upon increasing dilution of the composition; and/or iii) the pKₐ of the composition is greater than the pKₐ of the diluted product.

In another embodiment, the present invention is directed to a method of changing the visual perception of a composition. The method includes providing a composition. The composition includes at least one visual indicator dye and a surfactant. The visual indicator dye provides a first visual indication to the composition, wherein the first visual indication is selected from colorless or colored. The method also includes diluting the composition with water to achieve a second visual indication and a diluted product, and wherein: i) the extinction coefficient of the composition is less than the extinction coefficient of the diluted product measured at a wavelength from about 400 nm to about 700 nm; ii) a ratio of an absorbance measured between about 550-650 nm and an absorbance measured between about 395-440 nm increases upon increasing dilution of the composition; and/or iii) the pKₐ of the composition is greater than the pKₐ of the diluted product.

Additional embodiments, objects and advantages of the invention will become more fully apparent in the detailed description below.

### BRIEF DESCRIPTION OF THE DRAWINGS

The following detailed description will be more fully understood in view of the drawing in which:

FIG. 1 is a graph which illustrates the impact of a 10% detergent concentration of Abs1 (BTB=6 ppm) vs. a 6 ppm BTB solution containing no detergent.

The embodiments set forth in the drawing are illustrative in nature and are not intended to be limiting of the invention defined by the claims. Moreover, individual features of the drawing and the invention will be more fully apparent and understood in view of the detailed description.

### DETAILED DESCRIPTION

Studies have shown that the elevated use of blue dyes in current dishwashing products results in consumers washing more dishes with a given product dosage. This is believed to be due to the enhanced blue component of the wash water masking the removed soils. In addition, the blue wash water represents a signal of fresher/cleaner water at the start of the wash.

Current liquid detergent products contain conventional yellow, red and blue dyes, the upper level being limited by the need to maintain acceptable product appearance on the shelf. The concentration of blue dye in a product required to deliver the desired blue wash water results in a product that is too dark on the shelf. In addition to aesthetic concerns, dark products have resulted in complaints relating to slow dissolution. Therefore, in one embodiment, the composition has a maximum absorbance of 3 when measured at 1 cm at a wavelength from about 400 nm to about 700 nm.

Incorporated and included herein, as if expressly written herein, are all ranges of numbers when written in a “from X to Y” or “from about X to about Y” format. It should be understood that every limit given throughout this specification will include every lower or higher limit, as the case may be, as if such lower or higher limit was expressly written herein. Every range given throughout this specification will include every narrower range that falls within such broader range, as if such narrower ranges were all expressly written herein.

Unless otherwise indicated, weight percentage is in reference to weight percentage of the composition. All temperatures, unless otherwise indicated are in Celsius.

In one embodiment the composition comprises a visual indicator dye and a surfactant. Upon dilution of the composition with a volume of water, a diluted product is formed, and wherein: i) the extinction coefficient of the composition is less than the extinction coefficient of the diluted product measured at a wavelength from about 400 nm to about 700 nm; ii) a ratio of an absorbance measured between about 550-650 nm and an absorbance measured between about 395-440 nm increases upon increasing dilution of the composition; and/or iii) the pKₐ of the composition is greater than the pKₐ of the diluted product.

As used herein “volume of water” refers to a volume of water that is sufficient for rinsing or washing actions in a container such as a bucket or sink, that volume being from about 2000 ml to about 20000 ml, more typically from about 5000 ml to about 15000 ml of water in a container such as a bucket or sink having a volumetric capacity in the range of from about 1000 ml to about 20000 ml, more typically from about 5000 ml to about 15000 ml. The water may be from any water source, for example any municipal, commercial, household or other available water sources. The pH of the volume of water preferably is from 6.0 to 9.0, more preferably from 6.5 to 8.5.

As used herein, the pre-dilution composition (i.e. composition prior to dilution, undiluted composition) has a water concentration from about 0 to about 90%. Once a volume of water is added to the composition to form the diluted product, the diluted product has a water concentration from about 97.5% to about 99.95% and the concentration of the composition in the diluted product is from about 0.05% to about 2.5%.

The decrease in concentration, i.e. dilution, of the composition is accomplished by adding any volume of the composition to a volume of water, preferably from about 0.5 ml to about 20 ml of the composition to the volume of water. In one embodiment, the concentration of the composition upon dilution is about 800 to about 25000 ppm. In other embodiments, the concentration is from about 1000 to about 15000 ppm, about 2000 to about 12000 ppm, about 5000 ppm to about 10000 ppm, and about 800 to about 5000 ppm. In another embodiment, the concentration of the composition in the diluted product is about 0.08% to about 2.5%. In other embodiments, the concentration of the composition in the diluted product is from about 0.1% to about 1.5%, about 0.2% to about 1.2%, about 0.5% to about 1%, and about 0.08% to about 0.5%.

pH—In one embodiment, the liquid composition has a pre-dilution pH of from about 3.0-13. In another embodiment, the pH is from about 3.0 to 10. In additional embodiments, the pH is from about 5.0 to about 10, about 8.5 to about 10, about 6.5 to about 9.5, and about 7.0 to about 10. In another embodiment, the pH is from about 5.5-7.5. In another embodiment, the pH of the composition is substantially unchanged as compared with the diluted product. The pH of composition is considered “substantially unchanged” if the change in pH from the composition to the diluted product is less than about +/−1.0. The pH is measured as a 10 wt. % aqueous solution of the composition in distilled water, at room temperature (20° C.), and with a standard pH probe.

The composition may be in any suitable form including solid, liquid, or semi-liquid form like gels, or a unit dose form such as tablets, capsules or combinations of any of these forms. In one embodiment the composition is in liquid form. In another embodiment the composition is in a liquid aqueous form. In another embodiment, the composition is in gel form.

In one embodiment, the composition is adapted for dilution with a volume of water, wherein the extinction coefficient of the composition is less that the extinction coefficient of the diluted product measured at a wavelength from about 400 nm to about 700 nm. The extinction coefficient of the composition may be less than the extinction coefficient of the diluted product when measured anywhere within the recited wavelength range. Therefore, there may be instances where the extinction coefficient of the composition will be greater than the diluted product in one area of the range but less than the diluted product when measured at a different wavelength, and thus, this composition would still be considered to fall within the scope of the claim.

As is known in the art, the extinction coefficient of a particular substance is a measure of how well it scatters and absorbs electromagnetic radiation. The extinction coefficient or molar absorptivity of a substance (ε) is a measure of the amount of electromagnetic radiation absorbed per unit concentration and is related to the pathlength (l) of a sample solution of the substance and the measured absorbance (A) according to the Beer-Lambert Law: ε=A/l. Generally, as a composition is diluted, the extinction coefficient of the composition remains essentially constant. Surprisingly, the composition of the present invention has a lower extinction coefficient than the diluted product. In certain embodiments, the extinction coefficient of the diluted product is at least about: 50%, 100%, 200%, 300%, 400%, 500%, and 600% greater than the extinction coefficient of the composition. In other embodiments, the extinction coefficient of the diluted product is from about 300% to about 500% and from about 400% to about 600% greater than the extinction coefficient of the composition.

In one embodiment, the extinction coefficient of the diluted product is greater than the extinction coefficient of the composition when measured at a wavelength of about 580 nm to about 650 nm. However, the extinction coefficient can behave differently for different wavelengths of the visible spectrum, therefore, the changes in the extinction coefficient of the composition upon dilution should be compared at similar wavelengths. For example, if a change is detected in the extinction coefficient of the composition at a wavelength of about 600 nm, then the extinction coefficient of the composition measured at 600 nm should be compared with that of the diluted product measured at 600 nm.

In an additional embodiment, the composition is adapted for dilution with a volume of water, wherein a ratio of an absorbance measured at a wavelength between about 550-650 nm and an absorbance measured at a wavelength between about 395-450 nm increases upon increasing dilution. In one embodiment, the ratio of the absorbance is measured at a wavelength between about 615-635 nm and an absorbance measured at a wavelength between about 395-435 nm. As can be seen in Table 1, as the composition is diluted to form a diluted product at a concentration of 40% and then further diluted to form a second diluted product of 5%, the ratio of the diluted product increases from 0.37 (at 40% concentration) to 1.16 (at 5% concentration) which is approximately a 3.14 fold change in the ratio. In one embodiment, the ratio increases by a factor of at least about 2. In additional embodiments, the ratio changes by a factor of at least about 3, 3.5, 4, 4.5, and 5. In those embodiments where the first visual indication is colorless and the second visual indication is blue, the ratio of an absorbance measured between about 615-635 nm and an absorbance measured at a wavelength between about 395-435 nm would be infinity.

In another embodiment, the pKₐ of the composition is greater than the pKₐ of the diluted product. An acid dissociation constant, denoted by Kₐ, is an equilibrium constant for the dissociation of a weak acid. Values of Kₐ vary over many orders of magnitude, so it is common to take the logarithm to base ten of the value: pKₐ=−log₁₀Kₐ. It is easier to compare the strengths of different acids by comparing pKₐ values as they vary over a much smaller range. In one embodiment, the pKₐ of the composition is at least 0.5 points higher than the pKₐ of the diluted product. In other embodiments, the pKₐ is about 1.0 point higher, about 1.5 points higher, and about 2.0 or more points higher. It should be noted that when discussing the pKₐ shift of the composition, we are referring to the pKₐ shift of the dye within the composition.

In one embodiment, the visual indicator dye is capable of a first visual indication and capable of a second visual indication. As used herein “visual indication” means a visually perceived cue or visual color. The method for measuring absorbance of the first visual indication is via a 1 cm path length via standard UV/visible absorbance methodology. In one embodiment, the first visual indication is selected from the group consisting of colorless or colored and the second visual indication is selected from the group consisting of blue, green, or a combination thereof. In another embodiment, the first visual indication is selected from colorless and a color characterized by an absorbance measured at 1 cm at a wavelength of 420-440 nm having a minimum of about 0 to a maximum of about 2.4; at a wavelength of 520-540 nm having a minimum of about 0.04 to a maximum of about 0.90; at a wavelength of 620-640 nm having a minimum of about 0.04 to a maximum of about 2.2. In one embodiment, the first visual indication is characterized by a maximum absorbance of about 3 when measured at a wavelength of 420-440 nm, 520-540 nm, or 620-640 nm. In one embodiment, the first color is selected from colorless (lack of color), blue, green, purple, pink, red, orange and yellow. The absorbance spectra are measured on an instrument known as the ColorQuest® XE Spectrometer (Hunter Lab).

The second visual indication occurs after dilution. The method for measuring absorbance of the second visual indication includes diluting the liquid composition in deionized water such that the concentration of the liquid composition is 0.12 wt %. Absorbance can also be measured using standard UV/visible absorbance methodology at a path length of 5 cm. In one embodiment, the second visual indication is selected from a color characterized by an absorbance measured at a path length of 5 cm at a wavelength of 420-440 nm having a maximum of about 0.058; at a wavelength of 520-540 nm having a maximum of about 0.050; at a wavelength of 620-640 nm having a minimum of about 0.060 and a maximum of about 2.2. In another embodiment, the second visual indication is characterized by a maximum absorbance of about 0.06 when measured at 5 cm at a wavelength of 420-440 nm and 520-540 nm, and a minimum of 0.06 when measured at a wavelength of 620-640 nm. In one embodiment the second visual indication is blue. A ratio of 420-440 nm and 620-640 nm (yellow & blue to get a green to blue color range) with minimal 520-540 nm (red) corresponds to a visual perception of the color blue. Without being limited by a theory, it is believed that the second visual indication wavelengths, which correspond to the visual appearance of blue color for the solution, indicate to users of the composition that the volume of water is “clean” and may still be utilized to wash or rinse items being cleaned or rinses. Other colors may also be used as the second visual indication which, for example, mask the dirty water and therefore make the water appear to be cleaner, or just colored, instead of making the water appear the more natural blue.

The change in visual indication from the first visual indication to the second visual indication may be achieved by various means including, for example, visual indicator dyes, encapsulation, and water soluble beads filled with dye, pigments, opacifiers, and mixtures thereof. Surprisingly, it has been discovered that a change in pH is not necessary to initiate or carry out the change in the visual indication. This is true even in those cases where the dyes being used are generally categorized as pH indicator dyes. Without being limited by theory, in at least one embodiment, it is believed that there is an interaction between the dye and the surfactant where the surfactant binds the dye and upon dilution, the dye disassociates and has the second visual indication, in one embodiment this is blue. Additionally, it is believed that the more hydrophobic the dye the more interaction (in one embodiment, encapsulation) of dye. For example, in one embodiment, there is an interaction between alkyl ethoxy sulfonate surfactant and bromothymol blue visual indicator dye. Further evidence for the lack of necessity of the pH change and for the interaction of the dye and surfactant can be found in the Examples.

visual indicator dye—Can be a single or multiple dyes that give a visual indication change, preferably a color change upon dilution. In one embodiment, the amount of visual indicator dye in the composition may be from about 1 ppm to about 2000 ppm. In another embodiment, the amount can be from about 5 ppm to 500 ppm. In another embodiment, the amount can be from about 10 ppm to 200 ppm. In an additional embodiment, the amount can be from about 30 ppm to about 80 ppm.

In one embodiment, the visual indicator dye(s) may be selected from Formula A:

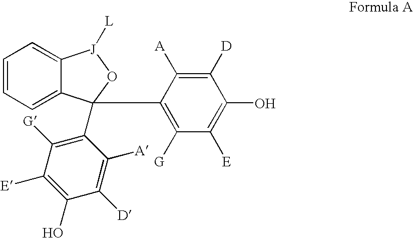

where A and A′ are independently selected from hydrogen, linear or branched C₁-C₁₂ alkyl, preferably selected from hydrogen and methyl (C₁ alkyl). In one embodiment, A and A′ are selected as both hydrogen or both methyl (C₁ alkyl). D and D′ are independently selected from hydrogen, linear or branched C₁-C₁₂ alkyl, chlorine (Cl) and bromine (Br). In one embodiment, D and D′ are selected from hydrogen, branched C₃ alkyl (isopropyl), chlorine (Cl) and bromine (Br). In another embodiment, D and D′ are both selected as hydrogen, branched C₃ alkyl (isopropyl), chlorine (Cl) or bromine (Br). E and E′ are independently selected from hydrogen, linear or branched C₁-C₁₂ alkyl, chlorine (Cl) and bromine (Br). In one embodiment, E and E′ are selected from hydrogen, methyl (C₁ alkyl), branched C₃ alkyl (isopropyl) and bromine (Br). In another embodiment, E and E′ are both selected as hydrogen, methyl (C₁ alkyl), branched C₃ alkyl (isopropyl) and bromine (Br). G and G′ are independently selected from hydrogen, chlorine (Cl) or bromine (Br). In one embodiment, G and G′ are selected from hydrogen and bromine (Br). In another embodiment, G and G′ are both selected as hydrogen or bromine (Br). J-L is a —C═O (carbon double bonded to oxygen) or —SO₂ moiety. Further linear or branched C₁-C₁₂ alkyl that are not already listed above are methyl (—CH₃), ethyl (—C₂H₅), isopropyl (—CH(CH₃)₂), butyl (—C₄H₉), isobutyl (—CH(CH₃)(C₂H₅)).

In another embodiment, the visual indicator dyes(s) may be selected from the salts of Formula A shown below as Formula B:

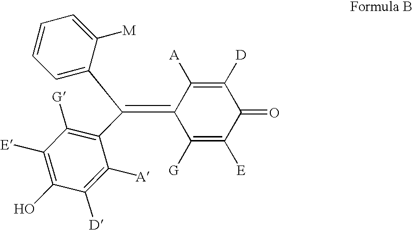

A and A′, D and D′, E and E′ and G and G′ of Formula B are as described above in Formula A. M of Formula B is selected from SO₃⁻, CO_{2′} and mixtures thereof.

In an additional embodiment, the visual indicator dye may be selected from the group of bromocresol purple (reported pKₐ of 6.3 @ 25° C.), bromothymol blue (reported pKa of 7.1 @ 25° C.), bromocresol green (reported pKa of 4.7 @ 25° C.), bromophenol blue (reported pKa of 4.0 @ 25° C., bromoxylenol blue (reported pKa of 7.0 @ 25° C.) and mixtures thereof. Likewise, the salts of these visual indicator dyes may also be utilized. In one embodiment, selecting a pH dye comprising an apparent pKa close to the pH of the liquid composition gives the most noticeable visual indication change from the first visual indication to the second visual indication.

### Surfactants

The detergent compositions of the present composition may comprise surfactants selected from the group consisting of anionic, amphoteric, zwitterionic, nonionic, cationic and mixtures thereof.

### Anionic Surfactants

The anionic surfactant, when present, is at a level of at least 10%, such as from 15% to 40% and further from 25% to 50% by weight of the composition. In one embodiment, anionic surfactants when utilized as components of the compositions of the present application may be suitable anionic surfactants selected from water-soluble salts or acids of C₆-C₂₀ linear or branched hydrocarbyl, such as an alkyl, hydroxyalkyl or alkylaryl, having a C₁₀-C₂₀ hydrocarbyl component, more preferably a C₁₀-C₁₄ alkyl or hydroxyalkyl, sulphate or sulphonates. Suitable counterions include hydrogen, alkali metal cation or ammonium or substituted ammonium, further sodium.

Sulfate Or Sulphonate Surfactant—In one embodiment, the sulphonate surfactants are the alkali metal salts of C₁₀₋₁₆ alkyl benzene sulfonic acids. In a further embodiment, the sulphonate surfactants are the C₁₁₋₁₄ alkyl benzene sulfonic acids. In one embodiment, the alkyl group is linear and such linear alkyl benzene sulfonates are known as “LAS”. Alkyl benzene sulfonates, and particularly LAS, are well known in the art. Such surfactants and their preparation are described for example in U.S. Pat. Nos. 2,220,099 and 2,477,383. In one embodiment, the sulphonate surfactants are the sodium and potassium linear straight chain alkylbenzene sulfonates in which the average number of carbon atoms in the alkyl group is from about 11 to 14, for example, Sodium C₁₁₋₁₄, e.g., C₁₂, LAS.

In another embodiment, the sulfate surfactant comprises ethoxylated alkyl sulfate surfactants. Such materials, also known as alkyl ether sulfates or alkyl polyethoxylate sulfates, are those which correspond to the formula (I):

R′—O—(C₂H₄O)ₙ—SO₃M (formula (I))

wherein R′ of formula (I) is a C₈-C₂₀ alkyl group, n of formula (I) is from about 1 to 20, and M of formula (I) is a salt-forming cation. In one embodiment, R′ formula (I) is C₁₀-C₁₈ alkyl, n formula (I) is from about 1 to 15, and M formula (I) is sodium, potassium, ammonium, alkylammonium, or alkanolammonium. In another embodiment, R′ formula (I) is a C₁₂-C₁₆, n formula (I) is from about 1 to 6 and M formula (I) is sodium.

The alkyl ether sulfates will generally be used in the form of mixtures comprising varying R′ chain lengths and varying degrees of ethoxylation. Frequently such mixtures will inevitably also contain some unethoxylated alkyl sulfate materials, i.e., surfactants of the above ethoxylated alkyl sulfate formula wherein n=0. Unethoxylated alkyl sulfates may also be added separately to the compositions of this invention and used as or in any anionic surfactant component which may be present.

In one embodiment, the unalkoxylated, e.g., unethoxylated, alkyl ether sulfate, surfactants are those produced by the sulfation of higher C₈-C₂₀ fatty alcohols. Conventional primary alkyl sulfate surfactants have the general formula (II):

ROSO₃⁻M⁺ formula (II)

wherein R of formula (II) is typically a linear C₈-C₂₀ hydrocarbyl group, which may be straight chain or branched chain, and M of formula (II) is a water-solubilizing cation. Preferably R of formula (II) is a C₁₀-C₁₅ alkyl, and M of formula (II) is alkali metal. Most preferably R of formula (II) is C₁₂-C₁₄ and M of formula (II) is sodium.

The liquid composition may further comprise a polyanionic or oligomeric anionic surfactant, such as an alkyl glyceryl sulphonate and/or sulfate surfactants. Alkyl glyceryl sulphonate surfactants and/or alkyl glyceryl sulfate surfactants generally used have high monomer content (greater than 60 wt %). However, it has been found that for starch cleaning, monomer content should be minimized and oligomer content maximized. As used herein “oligomer” includes dimer, trimer, quadrimer, and oligomers up to heptamers of alkyl glyceryl sulfonate surfactant and/or alkyl glyceryl sulfate surfactant. Minimization of the monomer content may be from 0 wt % to about 60 wt %, from 0 wt % to about 55 wt %, from 0 wt % to about 50 wt %, from 0 wt % to about 30 wt %, by weight of the alkyl glyceryl sulfonate surfactant and/or alkyl glyceryl sulfate surfactant present.

The alkyl glyceryl sulfonate surfactant and/or alkyl glyceryl sulfate surfactant for use herein include such surfactants having an alkyl chain length from C₁₀₋₄₀, C₁₀₋₂₂, C₁₂₋₁₈, and C₁₆₋₁₈. The alkyl chain may be branched or linear, wherein when present, the branches comprise a C₁₋₄ alkyl moiety, such as methyl (C₁) or ethyl (C₂). Generally, the structures of suitable alkyl glyceryl sulfonate surfactant oligomers that may be used herein include (A) dimers; (B) trimers, and (C) tetramers and higher oligomers not exemplified specifically below:

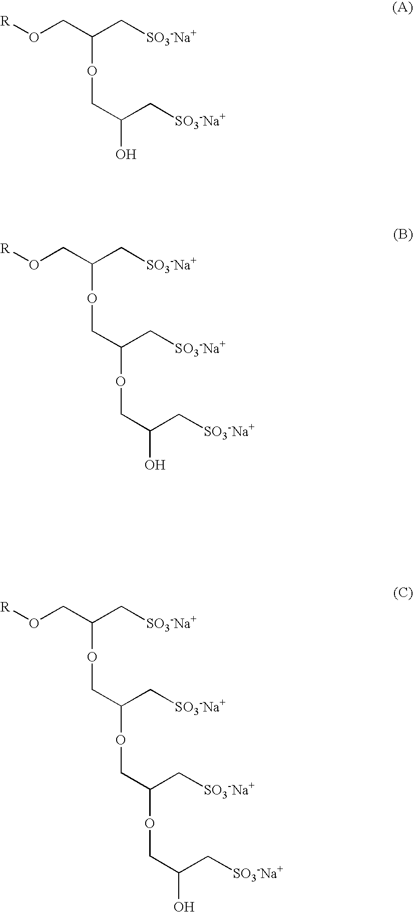

One of skill in the art will recognize that the counter-ion may be substituted with other suitable soluble cations other than the sodium shown above. R in the above structures (A)-(C) is from C₁₀₋₄₀, C₁₀₋₂₂, C₁₂₋₁₈, and C₁₆₋₁₈. The alkyl chain may be branched or linear, wherein when present, the branches comprise a C₁₋₄ alkyl moiety, such as methyl (C₁) or ethyl (C₂). One of skill in the art will also recognize that the corresponding alkyl glyceryl sulfate surfactant oligomers may also have similar structures with the SO₃⁻ moiety being an OSO₃⁻ moiety. When present in a detergent composition, the alkyl glyceryl sulfonate surfactant oligomer mixture is present from 0.1% to 10%, 0.5% to 5%, 1.0% to 4% by weight of the detergent composition

Other sulfate or sulphonate surfactants suitable include mid-chain branched alkyl sulfates as discussed in U.S. Pat. No. 6,020,303 and U.S. Pat. No. 6,060,443; mid-chain branched alkyl alkoxy sulfates as discussed in U.S. Pat. No. 6,008,181 and U.S. Pat. No. 6,020,303; modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548; methyl ester sulphonate (MES); and alpha-olefin sulphonate (AOS).

### Amphoteric Surfactants

Amphoteric surfactants that may be useful in the present composition are selected from amine oxide surfactants. Amine oxides are semi-polar nonionic surfactants and include water-soluble amine oxides containing one alkyl moiety of from about 10 to about 18 carbon atoms and 2 moieties selected from the group consisting of alkyl groups and hydroxyalkyl groups containing from 1 to 3 carbon atoms; water-soluble phosphine oxides containing one alkyl moiety of from 10 to 18 carbon atoms and 2 moieties selected from the group consisting of alkyl groups and hydroxyalkyl groups containing from about 1 to about 3 carbon atoms; and water-soluble sulfoxides containing one alkyl moiety of from about 10 to about 18 carbon atoms and a moiety selected from the group consisting of alkyl and hydroxyalkyl moieties of from 1 to 3 carbon atoms. Preferred amine oxide surfactants in particular include C₁₀-C₁₈ alkyl dimethyl amine oxides and C₈-C₁₂ alkoxy ethyl dihydroxy ethyl amine oxides.

Other suitable, non-limiting examples of amphoteric detergent surfactants that are useful in the present composition include amido propyl betaines and derivatives of aliphatic or heterocyclic secondary and ternary amines in which the aliphatic moiety can be straight chain or branched and wherein one of the aliphatic substituents contains from 8 to 24 carbon atoms and at least one aliphatic substituent contains an anionic water-solubilizing group.

The amphoteric surfactant, when present, is present in the composition in an effective amount such as from about 0.1% to about 40%, further such as about 0.1% to about 20%, even further such as about 0.5% to about 15% by weight of the composition.

### Nonionic Surfactants

Nonionic surfactants which may be included can be found in “Surface Active Agents and Detergents” (Vol. I and II by Schwartz, Perry and Berch), U.S. Pat. No. 3,929,678, issued Dec. 30, 1975 to Laughlin, et al. at Column 23, line 58 through Column 29, line 23, and U.S. Pat. No. 7,214,650 issued May 8, 2007.

The nonionic surfactant, when present in the composition, is present in an effective amount, such as from about 0.1% to about 40%, further from about 0.1% to about 20%, even further from about 0.5% to about 15%, by weight of the composition.

### Other Anionic Surfactants

Other anionic surfactants may include C₁₀-C₁₈ alkyl alkoxy carboxylates preferably comprising 1-5 ethoxy units and sulfonated fatty acid ester (MES) surfactants. The anionic surfactant, when present, is at a level of at least 15%, such as from 20% to 40% and further from 25% to 40% by weight of the composition.

### Cationic Surfactants

Cationic surfactants when utilized as components of the composition of the present application may be selected from non quaternary ammonium surfactants which can have up to 26 carbon atoms that include, but are not limited to alkoxylate quaternary ammonium (AQA) surfactants as discussed in U.S. Pat. No. 6,136,769; dimethyl hydroxyethyl quaternary ammonium as discussed in 6,004,922; polyamine cationic surfactants as discussed in WO 98/35002, WO 98/35003, WO 98/35004, WO 98/35005, and WO 98/35006; cationic ester surfactants as discussed in U.S. Pat. Nos. 4,228,042, 4,239,660 4,260,529 and U.S. Pat. No. 6,022,844; and amino surfactants as discussed in U.S. Pat. No. 6,221,825 and WO 00/47708, specifically amido propyldimethyl amine.

Suitable cationic surfactants may also be found in “Surface Active Agents and Detergents” (Vol. I and II by Schwartz, Perry and Berch), U.S. Pat. No. 3,929,678, issued Dec. 30, 1975 to Laughlin, et al. at Column 23, line 58 through Column 29, line 23, and U.S. Pat. No. 7,214,650 issued May 8, 2007.

Polyquaternary ammonium compounds can also be useful as cationic surfactants in the present compositions and are described in more detail in the following patent documents: EP 803,498; GB 808,265; GB 1,161,552; DE 4,203,489; EP 221,855; EP 503,155; EP 507,003; EP 803,498; FR 2,523,606; JP 84-273918; JP 2-011,545; U.S. Pat. No. 3,079,436; U.S. Pat. No. 4,418,054; U.S. Pat. No. 4,721,512; U.S. Pat. No. 4,728,337; U.S. Pat. No. 4,906,413; U.S. Pat. No. 5,194,667; U.S. Pat. No. 5,235,082; U.S. Pat. No. 5,670,472; Weirong Miao, Wei Hou, Lie Chen, and Zongshi Li, Studies on Multifunctional Finishing Agents, Riyong Huaxue Gonye, No. 2, pp. 8-10, 1992; Yokagaku, Vol. 41, No. 4 (1992); and Disinfection, Sterilization, and Preservation, 4^{th} Edition, published 1991 by Lea & Febiger, Chapter 13, pp. 226-30. The products formed by quaternization of reaction products of fatty acid with N,N,N′,N′, tetraakis(hydroxyethyl)-1,6-diaminohexane are also suitable for use in the present invention.

Cationic starch based on common maize starch or potato starch, containing 25% to 95% amylose and a degree of substitution of from 0.02 to 0.09, such as that available from Cerestar under the trade name C*BOND® and National Starch under the trade name CATO® A2 may also be utilized as cationic surfactants/fabric softening additives. Also cationic phosphorylated starch such as that discussed in U.S. Pat. No. 4,876,336 (Table II, samples A and F) and in copending application US 2005-0054553, filed Jun. 27, 2004.

The cationic surfactant, when present in the composition, is present in an effective amount, such as from about 0.1% to about 40%, further from about 1% to about 27%, even further from about 5% to about 20%, by weight of the composition.

The compositions of the present composition are suitable for use in cleaning hard surfaces, for example any kind of surfaces typically found in houses like kitchens, bathrooms, or in car interiors or exteriors, e.g., floors, walls, tiles, windows, sinks, showers, shower plastified curtains, wash basins, WCs, dishes, fixtures and fittings and the like made of different materials like ceramic, vinyl, no-wax vinyl, linoleum, melamine, glass, any plastics, plastified wood, metal or any painted or varnished or sealed surface and the like. Hard-surfaces also include household appliances including, but not limited to, refrigerators, freezers, washing machines, automatic dryers, ovens, microwave ovens, dishwashers and so on.

In one embodiment the composition is suitable for cleaning dishware including dishes, cups, cutlery, glassware, food storage containers, cutlery, cooking utensils, sinks and other kitchen surfaces. In another embodiment the composition is suitable for cleaning fabrics including clothing, towels, sheets, drapery, rugs, and other cloth items.

Additionally, in another embodiment, the present application relates to methods of changing the visual perception of a composition comprising: a) providing a composition comprising at least one visual indicator dye and a surfactant, wherein the visual indicator dye provides a first visual indication to the composition and the first visual indication is selected from colorless or a color; and b) diluting the composition with water to achieve a second visual indication and a diluted product, wherein upon dilution of the composition the composition is operable to exhibit at least one of: i) an increase in the extinction coefficient of the composition measured at a wavelength from about 400 nm to about 700 nm; ii) an increase in a ratio of absorbance measured between about 550-650 nm and an absorbance measured between about 395-440 nm; and iii) the pKa of the composition is at least about 1 point greater than the pKa of the diluted product. The composition can have any combination of the variations described previously.

### EXAMPLES

Example of color change—pH is kept constant upon dilution—As shown in Tables 1 and 2 below, bromothymol blue (BTB) is assessed in representative nil-dye versions of representative hand dishwashing products: a) Dawn® Bleach Alternative, b) Dreft®, and c) nil-dye Fairy® Liquid. In a typical procedure, BTB is directly added to the hand dishwashing detergent (60 ppm BTB) and the visible spectrum monitored (λ=400-700 nm) as a function of product dilution with deionized water. After each dilution, the detergent solution is adjusted to pH 9.0 with 0.1% NaOH and the ratio of absorbances at λₘₐₓ=615-635 nm (Abs1) and λₘₐₓ=395-435 nm (Abs2) measured. For comparison, a 60 ppm aqueous solution of BTB is prepared and sequentially diluted with deionized water, the pH again adjusted to 9.0 after each dilution (Table 2).

TABLE 1

| | BTB in | BTB in | BTB in nil-dye | Fairy ® |
|---|---|---|---|---|
| Product | Dawn ® BA | Dreft ® | Fairy ® Liquid | Liquid |
| Conc. (%) | λₘₐₓ = 615-635 nm:λₘₐₓ = 395-435 nm (Abs1:Abs2) | | | |
| 40.00 | 0.37 | 0.38 | — | 1.16 |
| 20.00 | 0.45 | 0.48 | 0.50 | 1.13 |
| 10.00 | 0.72 | 0.60 | 0.73 | 1.10 |
| 5.00 | 1.16 | 1.06 | 1.15 | 1.16 |
| 2.50 | 2.35 | 1.97 | 1.91 | 1.09 |
| 1.25 | 3.58 | 8.63 | 3.70 | 1.23 |
| 0.63 | 25.46 | — | 5.20 | 1.09 |
| 0.31 | — | — | 5.39 | 1.80 |

For the dishwashing detergents containing BTB, the ratio Abs1:Abs2 increases upon dilution, the most significant increase occurring at product concentrations ≦2.5%. In contrast, dilution of an aqueous solution of 60 ppm BTB (see Table 2), gives no significant change in the ratio of the two absorbance maxima at all dilutions. Similarly, dilution of a commercial Fairy® Liquid detergent (UK), containing a mixture of F&DC Blue #1 and F&DC Yellow #5, yields minimal change in the ratio of Abs1/Abs2. Absorption measurements for Tables 1 and 2 are made on an HP UV/Visibile 8453 Spectrophotometer (Hewlett-Packard).

TABLE 2

| Product | BTB in | |
|---|---|---|
| Conc. (%) | Water (ppm) | Abs1:Abs2 |
| 20 | 12.0 | 4.16 |
| 18 | 10.8 | 4.23 |
| 16 | 9.6 | 4.29 |
| 12 | 7.2 | 4.31 |
| 10 | 6.0 | 4.47 |
| 8 | 4.8 | 4.35 |
| 6 | 3.6 | 4.52 |
| 5 | 3.0 | 4.37 |
| 4 | 2.4 | 4.59 |
| 2 | 1.2 | 4.14 |
| 1 | 0.6 | 4.68 |
| 0.5 | 0.3 | 5.00 |

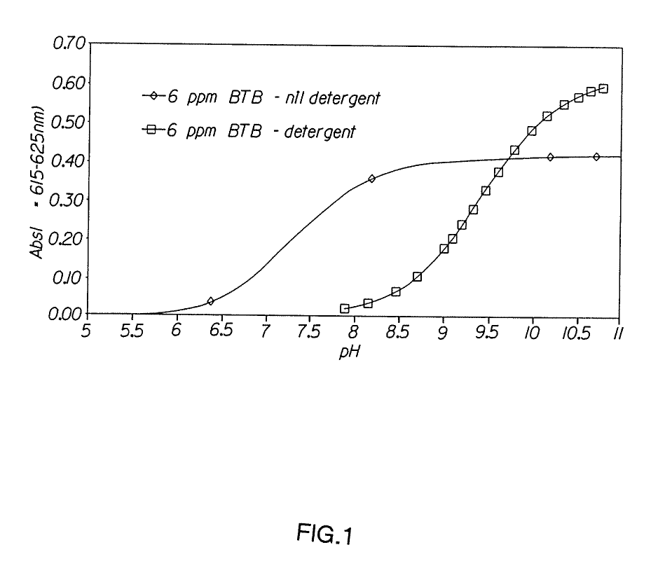

Example of color change—pKa measurements—As outlined in the methods described by Brode (Journal of the American Chemical Society, Vol. 46, pp 581-596, 1924) and Puschett et al (Talanta, Vol. 38, Issue #3, pp 335-338, 1991), the pKa of bromothymol blue (BTB) is estimated in water and a model dishwashing detergent containing approximately 30% surfactant (combination of alkylethoxysulfonate and amine oxide). In the absence of detergent, stock solutions of BTB (6-20 ppm) are first adjusted to a pH of 11-12 and titrated with 1% HCl down to a pH of 4.0. After each pH adjustment the absorbance peak at 617 nm (Abs1) is measured and pKa estimated from the abscissa of the point of inflection. In similar fashion, BTB is added at a 60 ppm level to the dishwashing detergent, diluted 10-100 fold with deionized water and titrated with 1% HCl. At each pH, the absorbance maximum is measured in the 615-625 nm wavelength region (Abs1) as seen in FIG. 1.

In the absence of detergent, pKa of BTB is estimated to be 7.3, slightly above the literature value of 7.1. Addition of detergent raises the pKa, dependent on the product concentration as can be seen in Table 3.

TABLE 3

| Detergent | |
|---|---|
| Conc (%) | pKa |
| 0 | 7.3 |
| 1 | 8.2 |
| 5 | 9.0 |
| 10 | 9.4 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

The foregoing description of various embodiments and principles of the invention has been presented for the purposes of illustration and description. It is not intended to be exhaustive or to limit the inventions to the precise forms disclosed. Many alternatives, modifications, and variations will be apparent to those skilled the art. Moreover, although multiple inventive aspects and principles have been presented, these need not be utilized in combination, and various combinations of inventive aspects and principles are possible in light of the various embodiments provided above. Accordingly, the above description is intended to embrace all possible alternatives, modifications, aspects, combinations, principles, and variations that have been discussed or suggested herein, as well as all others that fall within the principles, spirit and scope of the inventions as defined by the claims.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changed and modifications that are within the scope of this invention.

1. A composition, comprising:
(a) at least one visual indicator dye, and
(b) a surfactant;
wherein the composition is adapted for dilution with a volume of water to form a diluted product, the diluted product having an extinction coefficient, and wherein: i) the composition has an extinction coefficient of less than the extinction coefficient of the diluted product measured at a wavelength from about 400 nm to about 700 nm; ii) a ratio of an absorbance measured between about 550-650 nm and an absorbance measured between about 395-450 nm increases upon increasing dilution of the composition; and/or iii) the pKₐ of the composition is greater than the pKₐ of the diluted product.

2. The composition of claim 1, wherein the extinction coefficient of the diluted product is greater than the extinction coefficient of the composition when measured at a wavelength from about 580 nm to about 650 nm.

3. The composition of claim 1, wherein the extinction coefficient of the diluted product is from about 100% to about 400% greater than the extinction coefficient of the composition.

4. The composition of claim 1, wherein the extinction coefficient of the diluted product is at least about 400% greater than the extinction coefficient of the composition.

5. The composition of claim 1, wherein the ratio increases by at least about a factor of 2.

6. The composition of claim 1, wherein the pKₐ of the composition is at least 0.5 points greater than the pKₐ of the diluted product.

7. The composition of claim 1, wherein the visual indicator dye is capable of a first visual indication and capable of a second visual indication.

8. The composition of claim 7, wherein the first visual indication is selected from the group consisting of colorless or colored and the second visual indication is selected from the group consisting of blue, green, or a combination thereof.

9. The composition of claim 7, wherein the visual indicator dye is operable to exhibit the first visual indication prior to a dilution of the composition and to exhibit the second visual indication after dilution of the composition.

10. The composition of claim 7, wherein the second visual indication arises from a mechanism comprising encapsulation.

11. The composition of claim 7, wherein the composition has a maximum absorbance prior to dilution of about 3 when measured at 1 cm at a wavelength from about 400 nm to about 700 nm.

12. The composition of claim 7, wherein the concentration of the composition in the diluted product is from about 800 to about 25000 ppm.

13. The composition of claim 7, wherein the concentration of the composition in the diluted product is from about 800 to about 5000 ppm.

14. The composition of claim 1, wherein the pH of the composition is from about 3.0 to about 10.0.

15. The composition of claim 1, wherein the pH of the composition is from about 5.5 to about 7.5.

16. The composition of claim 1, wherein the pH of the composition is from about 7.0 to about 10.

17. The composition of claim 1, wherein the at least one visual indicator dye is selected from the group consisting of bromocresol purple, bromothymol blue, bromocresol green, bromophenol blue, bromoxylenol blue and mixtures thereof.

18. The composition of claim 1, wherein the surfactant comprises an alkyl ethoxy sulfonate.

19. A method of changing the visual perception of a composition comprising the steps of:
a) providing a composition comprising at least one visual indicator dye and a surfactant, wherein the visual indicator dye provides a first visual indication to the composition, wherein the first visual indication is selected from colorless or a color, and
b) diluting the composition with water to achieve a second visual indication and to produce a diluted product, wherein: i) the extinction coefficient of the composition is less than the extinction coefficient of the diluted product measured at a wavelength from about 400 nm to about 700 nm; ii) a ratio of an absorbance measured between about 550-650 nm and an absorbance measured between about 395-440 nm increases upon increasing dilution of the composition; and/or iii) the pKₐ of the composition is greater than the pKₐ of the diluted product.

20. The method of claim 19, wherein the first visual indication is characterized by a maximum absorbance of 3 when measured at 1 cm at a wavelength of 420-440 nm, 520-540 nm, or 620-640 nm.

21. The method of claim 19, wherein the second visual indication is characterized by a maximum absorbance of about 0.06 when measured at 5 cm at a wavelength of 420-440 nm and 520-540 nm, and a minimum of 0.06 at 620-640 nm.

22. The method of claim 19, wherein the surfactant comprises an anionic surfactant, an amphoteric surfactant, a nonionic surfactant, or any combination thereof, and is present in an amount of at least about 10%.

23. The method of claim 19, wherein the pH of the composition and the diluted product is substantially unchanged.

24. The method of claim 19, wherein the at least one visual indicator dye is selected from the group consisting of bromocresol purple, bromothymol blue, bromocresol green, bromophenol blue, bromoxylenol blue and mixtures thereof.

25. The method of claim 24, wherein the surfactant comprises an alkyl ethoxy sulfonate.
